(19) United States
(12) Patent Application Publication
(10) Pub. No.: US 2023/0129010 A1
(43) Pub. Date: Apr. 27, 2023

(54) INFORMATION PROCESSING METHOD

(71) Applicant: NEC Corporation, Minato-ku, Tokyo (JP)

(72) Inventor: Takuya HISAMOTO, Tokyo (JP)

(73) Assignee: NEC Corporation, Minato-ku, Tokyo (JP)

(21) Appl. No.: 17/910,052

(22) PCT Filed: Mar. 26, 2020
(86) PCT No.: PCT/JP2020/013587

§ 371 Date: Sep. 8, 2022

(51) Int. Cl. G06Q 10/02

(52) U.S. Cl. CPC G06Q 10/025

(57) ABSTRACT

An information processing system 100 of the present invention includes an acquisition unit 121 that acquires moving information representing a use state of transportation means by a user and visiting information representing a use state of a visited place by the user, in a predetermined area, and an association unit 122 that stores the moving information and the visiting information of the same user in association with each other.

### TECHNICAL FIELD

The present invention relates to an information processing method, an information processing system, and a program for processing information related to use states of transportation means and visited places by a user.

### BACKGROUND ART

When a user visits a distant area for sightseeing or a business trip or visits a neighboring area for shopping, the user often moves using transportation means such as a train, a bus, a taxi, and the like. The user moves in a specific area using such various transportation means, buys things in a facility such as a shop in the area, and receives services. Therefore, transportation means is indispensable for urging a user to use facilities, and plays a very important role for local revitalization.

In order to realize local revitalization including transportation means, the local area side provides information by means of websites or brochures to urge a user to act in the area. In particular, along with widespread of mobile information processing terminals such as smartphones, a user often searches for area information by using a mobile information processing terminal to determine the action in such an area. For example, a user searches for places of sightseeing spots or restaurants where the user can move and stay, while taking into account the current place and the free time, and determines the action.

Meanwhile, when a user determines the destination of the own action, the user needs to search for places of sightseeing spots or restaurants, and there is a case where the user cannot search for a place where the user wishes. In particular, when a free time is generated unexpectedly, it is difficult to search for a place where the user wishes in a short time.

As a technology that solves the above-described problem, Patent Literature 1 discloses a navigation device that provides a user with a list of drop-in facilities. Specifically, Patent Literature 1 generates a route based on the schedule of a user, and displays a list of drop-in facilities where the user can drop in when there is a free time. Then, when the user selects a drop-in facility from the list of drop-in facilities, the navigation device generates a route via the selected drop-in facility.

Patent Literature 1: JP 2003-302240 A

### SUMMARY

However, as described above, even providing information by means of websites or brochures or proposing a route by the system to urge a user to take actions in the area, it is difficult for service providers of the transportation means to gain further profits. The reason is that since the above-described transportation means such as a train, a bus, and a taxi have a high public nature, the fares are often regulated by the law or the like, so that the service providers cannot feely determine the fares. As a result, there is a problem that it is difficult for the service providers of the transportation means to gain further profits corresponding to the number or the frequency of the users, so that further local revitalization cannot be achieved.

In view of the above, an object of the present invention is to provide an information processing method, an information processing system, and a program capable of solving the problem described above, that is, a problem that it is difficult for service providers of the transportation means to gain further profits, so that further local revitalization cannot be achieved.

According to one aspect of the present invention, an information processing method includes
acquiring moving information representing a use state of transportation means by a user and visiting information representing a use state of a visited place by the user, in a predetermined area, and
storing the moving information and the visiting information of the same user in association with each other.

Further, according to one aspect of the present invention, an information processing system includes
an acquisition unit that acquires moving information representing a use state of transportation means by a user and visiting information representing a use state of a visited place by the user, in a predetermined area, and
an association unit that stores the moving information and the visiting information of the same user in association with each other.

Further, according to one aspect of the present invention, a program causes an information processing device to realize
an acquisition unit that acquires moving information representing a use state of transportation means by a user and visiting information representing a use state of a visited place by the user, in a predetermined area, and
an association unit that stores the moving information and the visiting information of the same user in association with each other.

With the configuration described above, the present invention enables service providers of the transportation means to gain more profits and enables further local revitalization.

### BRIEF DESCRIPTION OF DRAWINGS

FIG. 1 is a block diagram illustrating the overall configuration of an information processing system according to a first exemplary embodiment of the present invention.

FIG. 2 is a block diagram illustrating a configuration of a data aggregation device disclosed in FIG. 1.

FIG. 3 illustrates an example of information stored in the data aggregation device disclosed in FIG. 1.

FIG. 4 illustrates an example of information stored in the data aggregation device disclosed in FIG. 1.

FIG. 5 illustrates an example of information stored in the data aggregation device disclosed in FIG. 1.

FIG. 6 illustrates an exemplary action taken by the user disclosed in FIG. 1.

FIG. 7 illustrates an exemplary action of the user disclosed in FIG. 1.

FIG. 8 illustrates an example of information aggregated by the data aggregation device disclosed in FIG. 1.

FIG. 9 is a flowchart illustrating an operation of the data aggregation device disclosed in FIG. 1.

FIG. 10 is a block diagram illustrating a modification of the overall configuration of the information processing system according to the first exemplary embodiment of the present invention.

FIG. 11 is a block diagram illustrating a modification of the overall configuration of the information processing system according to the first exemplary embodiment of the present invention.

FIG. 12 is a block diagram illustrating a hardware configuration of an information processing system according to a second exemplary embodiment of the present invention.

FIG. 13 is a block diagram illustrating a configuration of the information processing system according to the second exemplary embodiment of the present invention.

FIG. 14 is a flowchart illustrating an operation of the information processing system according to the second exemplary embodiment of the present invention.

### EXEMPLARY EMBODIMENTS

### <First Exemplary Embodiment>

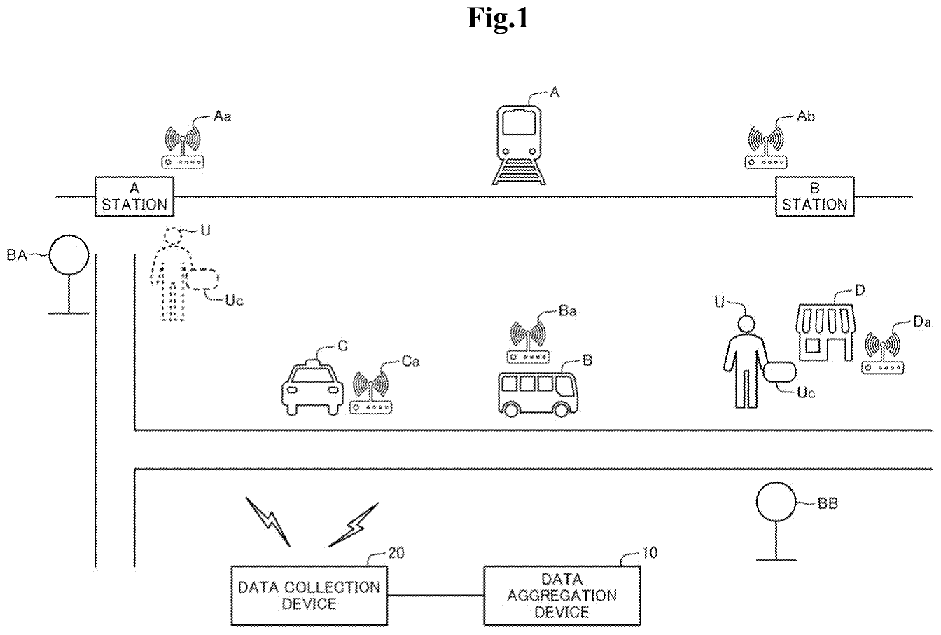

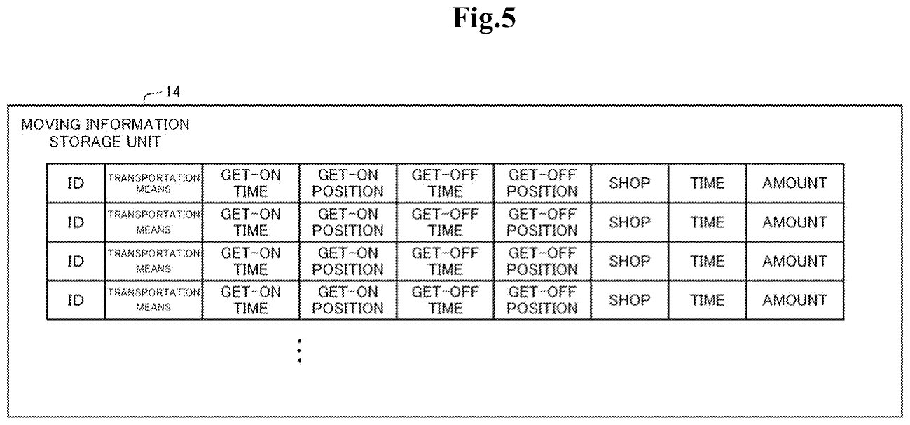

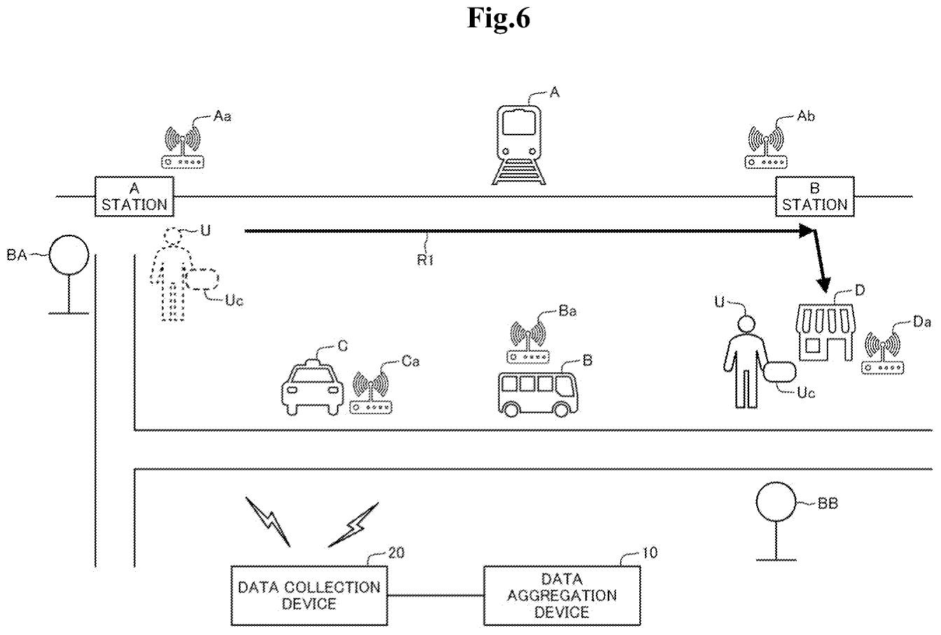

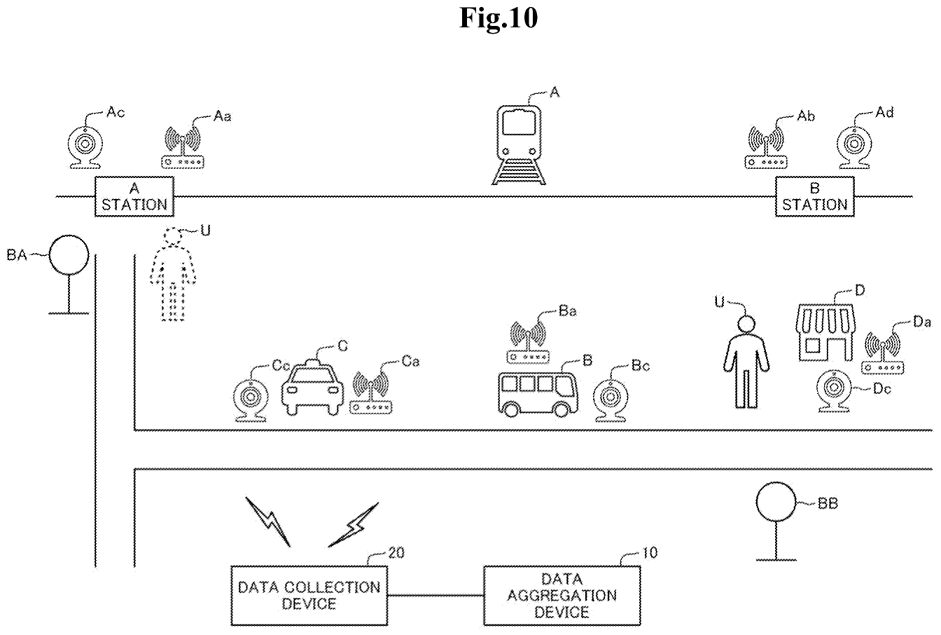

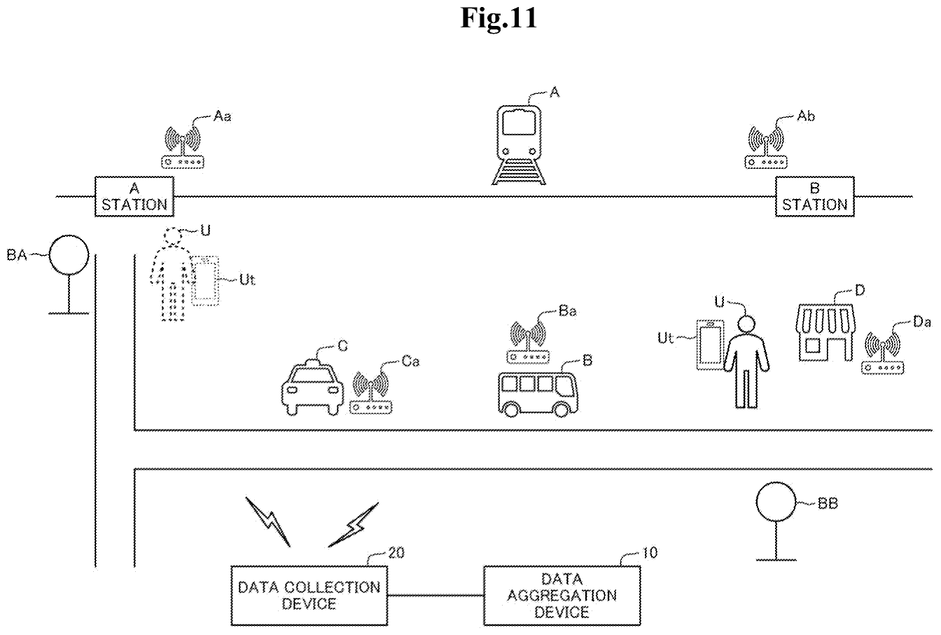

A first exemplary embodiment of the present invention will be described with reference to FIGS. 1 to 11. FIGS. 1 to 5 are diagrams for explaining a configuration of an information processing system, and FIGS. 6 to 9 are illustrations for explaining the processing operation of the information processing system. FIGS. 10 and 11 are illustrations for explaining other configurations of an information processing system.

### [Configuration]

An information processing system of the present invention is used to collect and aggregate information representing the action of a user U visiting a predetermined area such as a tourist site. In particular, the information processing system of the present embodiment is used to collect and aggregate moving information representing a use state of transportation means by the user U and visiting information representing a use state of a visited place by the user. As illustrated in FIG. 1, the information processing system includes a data collection device 20 that collects data of the user U, and a data aggregation device 10 that aggregates the collected information of the user. The data collection device 20 and the data aggregation device 10 are connected to each other over a network. The data collection device 20 is also connected to information acquisition devices Aa, Ab, Ba, Ca, and Da installed in a station of a train A, a bus B, a taxi C, a shop D, and the like over the network as described below. Hereinafter, the respective constituent elements will be described.

First, in the present embodiment, the transportation means used by the user U includes the train A, the bus B, and the taxi C, for example. However, the transportation means may be any transportation such as a rental bicycle or a rickshaw, for example. Further, in the present embodiment, the visited place to be used by the user U is, for example, the shop D that sells goods. However, the visited place may be any place such as a shop that provides a service, a theme park, a historical building, or the like. Note that the user U is not limited to a person visiting a predetermined area for sightseeing, but may be any person such as a person living in the area or neighborhood.

The information acquisition devices Aa and Ab installed at stations of the train A detect getting on and off by the user U at the stations where they are installed, and also acquire identification information for specifying the user U. For example, each of the information acquisition device Aa and Ab acquires user identification (ID) that is identification information of the user U, from a contactless integrated circuit (IC) card Uc that is touched to a card reader by the user U when getting on or off, via the card reader provided at the automatic ticket gate of the station. At that time, each of the information acquisition devices Aa and Ab accumulates, as moving information representing the use state of the transportation means by the user, information specifying the transportation means (transportation means name), the get-on time (moving time information), the get-on position (moving place information), the get-off time (moving time information), and the get-off position (moving place information), in association with the acquired user ID, and transmits it to the data collection device 20 over a network such as a wireless communication at arbitrary timing. For example, when the user U moves from the A station to the B station in FIG. 1, first, the information acquisition device Aa at the A station accumulates, as the moving information, the train A as the transportation means, the time passing through the ticket gate of the A station as the get-on time, and the position information of the A station as the get-on position, in association with the user ID of the user U who got on, and the information acquisition device Ab of the B station accumulates, as the moving information, the train A as the transportation means, the time passing through the ticket gate of the B station as the get-off time, and the position information of the B station as the get-off position, in association with the user ID of the user U who got off. Note that the information acquisition devices Aa and Ab may accumulate the moving information at the time of get-on and the moving information at the time of get-off of the same user U whose ID is the same as one unit of moving information, and transmit it to the data collection device 20.

The information acquisition device Ba installed on the bus B detects getting on and off by the user U in the bus B where it is installed, and also acquires identification information for specifying the user U. For example, the information acquisition device Ba acquires the user ID that is identification information of the user U, from a contactless IC card Uc touched to a card reader by the user U when getting on and off, via the card reader provided at the entrance/exit of the bus B. At that time, the information acquisition device Ba accumulates, as moving information representing the use state of the transportation means by the user, information specifying the transportation means (transportation means name), the get-on time (moving time information), the get-on position (moving place information), the get-off time (moving time information), and the get-off position (moving place information), in association with the acquired user ID, and transmits it to the data collection device 20 over a network such as a wireless communication at arbitrary timing. For example, when the user U moves from a bus stop BA near the A station to a bus stop BB near the B station, the information acquisition device Ba accumulates, as the moving information, the bus B as the transportation means, the time when getting on at the bus stop BA near the A station as the get-on time, the position information of the bus stop BA near the A station as the get-on position, the time when getting off at the but stop BB near the B station as the get-off time, and the position information of the bus stop BB near the B station as the get-off position, in association with the user ID of the user U.

The information acquisition device Ca installed on the taxi C detects getting on and off by the user U in the taxi C where it is installed, and also acquires identification information for specifying the user U. For example, the information acquisition device Ca acquires the user ID that is identification information of the user U, from the contactless IC card Uc touched to a card reader by the user U when getting on and off, via the card reader installed on the taxi C. At that time, the information acquisition devices Ca accumulates, as moving information representing the use state of the transportation means by the user U, information specifying the transportation means (transportation means name), the get-on time (moving time information), the get-on position (moving place information), the get-off time (moving time information), and the get-off position (moving place information), in association with the acquired user ID, and transmits it to the data collection device 20 over a network such as a wireless communication at any timing. For example, when the user U moves from the A station to the B station by the taxi C, the information acquisition device Ca accumulates, as the moving information, the taxi C as the transportation means, the time when getting on the taxi C at the A station as the get-on time, the position information of the A station as the get-on position, the time when getting off the taxi C at the B station as the get-off time, and the position information of the B station as the get-off position, in association with the user ID of the user.

The information acquisition device Da installed in the shop D acquires identification information specifying the user U and the money amount information representing the paid amount, when the user U makes a payment for goods or the like purchased by the user U at the shop D where it is installed. For example, the information acquisition device Da acquires the user ID that is identification information of the user U and the paid amount, from the contactless IC card Uc touched to a card reader by the user U when making a payment, via the card reader installed in the shop D. At that time, the information acquisition device Da accumulates, as visiting information representing the use state of the visited place by the user, information specifying the shop D, the time when the payment is made (visiting time information), and the paid amount, in association with the acquired user ID, and transmits it to the data collection device 20 over a network such as a wireless communication at arbitrary timing. For example, in the case where the user U purchases goods and makes a payment at the shop D near the B station in FIG. 1, the information acquisition device Da accumulates, as visiting information, the information of the shop D as a shop, the time when the payment is made as the time, and the paid amount, in association with the user ID of the user U. Note that the information specifying the shop D may include the position information of the shop D.

While the information acquisition devices Aa, Ab, Ba, Ca, and Da acquire moving information and visiting information of the user U by using the contactless IC card Uc held by the user U in the above description, it is not necessarily limited to use of the contactless IC card Uc. As described in modifications provided below, it is possible to specify the user by using a mobile information processing terminal such as a smartphone Ut held by the use U or performing face authentication to acquire moving information or visiting information of the user U.

Next, the data collection device 20 will be described. The data collection device 20 has a function of collecting moving information and visiting information of the user U from the information acquisition devices Aa, Ab, Ba, Ca, and Da. For example, the data collection device 20 is configured of one or a plurality of information processing devices provided on the network, and receives and stores moving information and visiting information of the user U transmitted from the information acquisition devices Aa, Ab, Ba, Ca, and Da automatically or through operation by an operator. Then, in response to a request from the data aggregation device 10 or at certain time intervals, the data collection device 20 transmits the moving information and the visiting information of the user U to the data aggregation device 10.

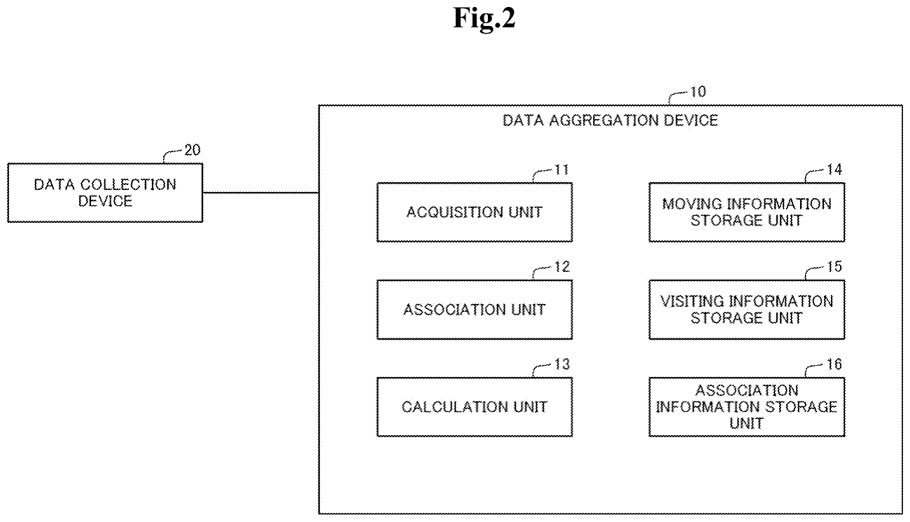

Next, configuration of the data aggregation device 10 will be described. The data aggregation device 10 is configured of one or a plurality of information processing devices each having an arithmetic device and a storage device. As illustrated in FIG. 2, the data aggregation device 10 includes an acquisition unit 11, an association unit 12, and a calculation unit 13 that are constructed by execution of a program by the arithmetic device. The data aggregation device 10 also includes a moving information storage unit 14, a visiting information storage unit 15, and an association information storage unit 16 that are formed in the storage device.

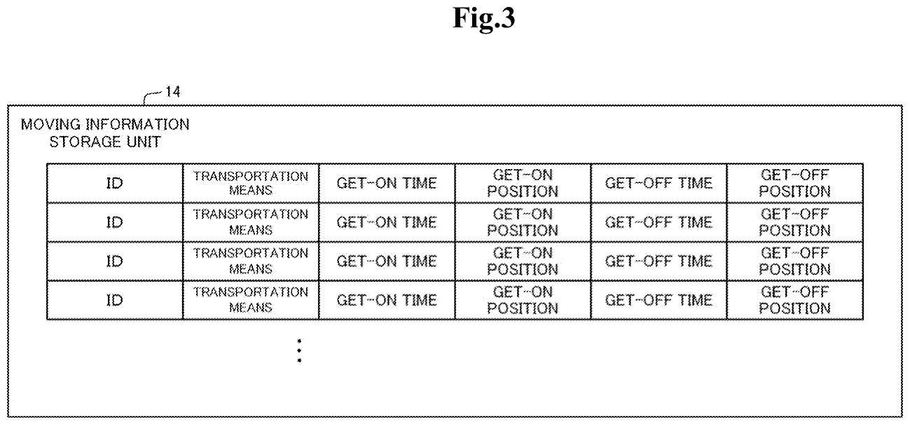

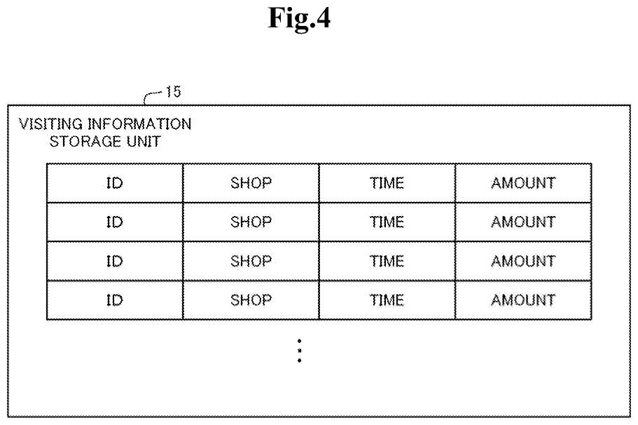

The acquisition unit 11 (acquisition means) receives the moving information and the visiting information of the user U transmitted from the data collection device 20, stores the moving information in the moving information storage unit 14, and stores the visiting information in the visiting information storage unit 15. Specifically, the moving information to be stored in the moving information storage unit 14 includes information specifying the transportation means (train name, bus name, taxi company, or the like), the get-on time, the get-on position (station name, bus stop, address, or the like), the get-off time, and the get-off position (station name, bus stop, address, or the like) that are associated with an ID that is identification information of the user U, as illustrated in FIG. 3. The visiting information of the user U to be stored in the visiting information storage unit 15 includes information specifying a shop (shop name and position), the payment time (visiting time information), and the paid amount that are associated with an ID that is identification information of the user U, as illustrated in FIG. 4.

The association unit 12 (association means) stores the moving information stored in the moving information storage unit 14 and the visiting information stored in the visiting information storage unit 15 in the association information storage unit 16 in associated with each other for the same user U. At that time, the association unit 12 associates the moving information and the visiting information of the same user U that are determined that the get-on position or the get-off position of the transportation means and the position of the shop D are almost the same positions that are positions corresponding to each other, and that the get-on time or the get-off time of the transportation means and the payment time at the shop D are almost the same time. For example, the association unit 12 extracts the moving information and the visiting information of the same user U, reads out the get-on position or the get-off position of the transportation means in the moving information and the information specifying the shop in the visiting information, and refers to the shop information stored in advance to confirm the address of the shop from the information specifying the shop. Then, when the address of the shop and the get-on position or the get-off position of the transportation means are located within a predetermined distance range, it is determined that the shop and the get-on position or the get-off position of the transportation means are almost the same. Moreover, the association unit 12 compares the get-on time or the get-off time of the transportation means in the moving information with the payment time in the visiting information, and when the payment time and the get-on time or the get-off time of the transportation means are in a predetermined time range, the association unit 12 determines that they are almost the same time.

As a result, by the association unit 12, the moving information and the visiting information that are information of the transportation means and the shop, used by the same user at almost the same position at almost the same time, are associated with each other. For example, as illustrated in FIG. 15, the association unit 12 associates information specifying the transportation means (train name, bus name, taxi company, or the like), the get-on time, the get-on position (station name, bus stop, address, or the like), the get-off time, the get-off position (station name, bus stop, address, or the like), the information specifying the shop (shop name and position), the payment time (visiting time information), and the paid amount, with the ID of the user U. However, the association unit 12 is not necessarily limited to association of the moving information and the visiting information of the time determined to be almost the same, and is not necessarily limited to association of the moving information and the visiting information of the positions determined to be almost the same. For example, the association unit 12 may associate the moving information and the visiting information of the same user regardless of the positions and the time of the transportation means and the shop.

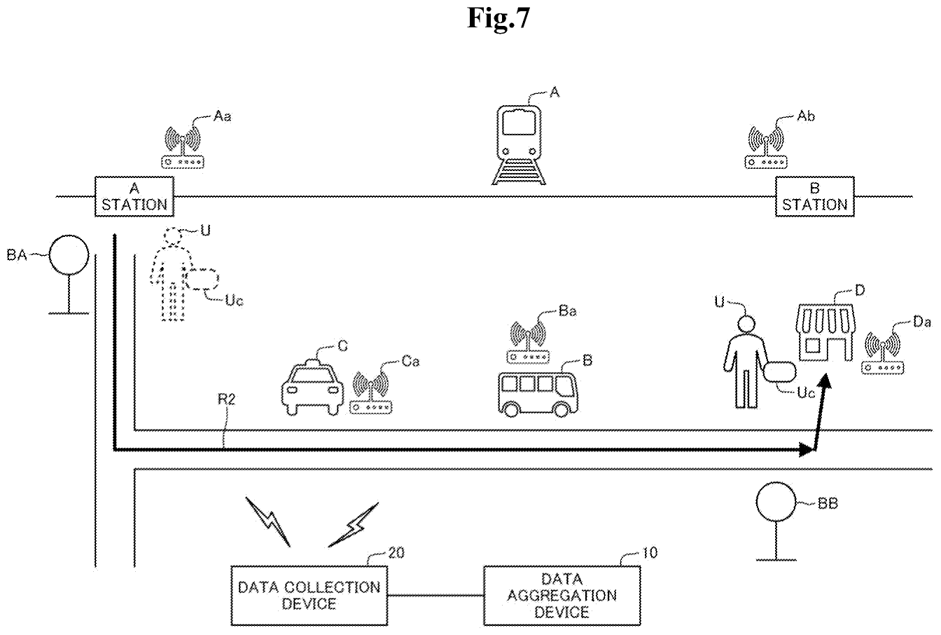

As described above, by associating the moving information and the visiting information of the user U with each other, it is possible to accumulate information such as the transportation means and the shop used by the user U. By using such information, as illustrated by an arrow R1 in FIG. 6 for example, it is possible to recognize that the user U moves from the A station to the B station by the train A and after getting off the train, uses the shop D, and also the paid amount of that time. Moreover, it is also possible to recognize the relationship between the get-on time or the get-off time of the train A and the payment time at the shop D. Further, as illustrated by an arrow R2 in FIG. 7, it is possible to recognize that the user U moves from the bus stop BA to the bus stop BB by the bus B and after getting off the bus, uses the shop D, and also the paid amount of that time.

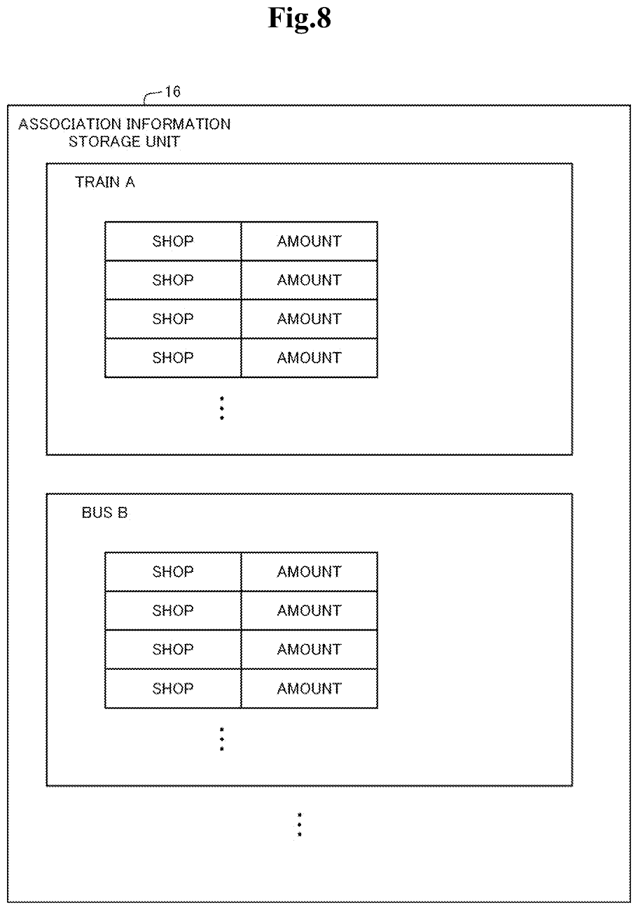

The calculation unit 13 (calculation means) uses the moving information and the visiting information associated as described above to aggregate the paid amount of the user U for each transportation means. For example, as illustrated in FIG. 8, the calculation unit 13 extracts information of the shop and the paid amount for each transportation means such as the train A or the but B, and calculates the total paid amount for each transportation means. At that time, the calculation unit 13 may perform aggregation in various manners such as calculating the total paid amount for each period or each hours determined in advance, with reference to the payment time, the get-on time, and the get-off time. Further, the calculation unit 13 calculates the amount returned to the service provider of the transportation means from the shop, by multiplying the total paid amount for each transportation means by a predetermined rate (for example, 10% or 5%). Note that the calculation unit 13 may calculate the amount to be returned to the service provider of the transportation means by means of any method from the moving information and the visiting information associated with each other as described above. The calculation unit 13 may transmit information representing the aggregation result such as the paid amount and the amount to be returned per transportation means as described above to the information processing devices of the service provider of each transportation means and each shop. Further, the calculation unit 13 may transmit not only the aggregation result but also a calculation formula used for aggregation and association information of the moving information and the visiting information serving as the basis for aggregation, to the information processing devices of the service provider of each transportation means and each shop.

While the total paid amount has been calculated for each transportation means such as the train A or the bus B in the above description, in the case where the train A and the bus B are provided by the same service provider, related service providers, or a group such as a union, one group may be handled as one transportation means. For example, when the train A and the bus B are provided by the same service provider, the total paid amount with respect to such a service provider may be calculated.

### [Operation]

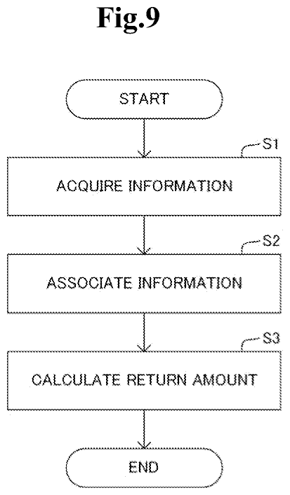

Next, operation of the information processing system described above will be described with mainly reference to the flowchart of FIG. 9. First, each time the user takes an action, the information acquisition devices Aa, Ab, Ba, Ca, and Da installed in the transportation means such as the train A, the bus B, and the taxi C and the visited place such as the shop D detect the action of the user U. That is, the information acquisition devices Aa, Ab, Ba, Ca, and Da acquire the user ID that is identification information of the user U from the contactless IC card Uc of the user U. Then, each of the information acquisition devices Aa, Ab, Ba, and Ca accumulates, as moving information representing the use state of the transportation means by the user U, information specifying the transportation means (transportation means name), the get-on time (moving time information), the get-on position (moving place information), the get-off time (moving time information), and the get-off position (moving place information), in association with the acquired user ID. Further, the information acquisition device Da accumulates, as visiting information representing the use state of the visited place by the user U, information specifying the shop D, the time when the payment was made (moving time information), and the paid amount (money amount information), in association with the acquired user ID. Then, the information acquisition devices Aa, Ab, Ba, Ca, and Da transmit the accumulated moving information to the data collection device 20 over a network such as a wireless communication at arbitrary timing.

Then, the data collection device 20 receives and stores therein the moving information and the visiting information of the user U transmitted from the information acquisition devices Aa, Ab, Ba, Ca, and Da. Then, in response to a request from the data aggregation device 10 or at certain time intervals, the data collection device 20 transmits the moving information and the visiting information of the user U to the data aggregation device 10.

Then, the data aggregation device 10 receives and stores therein the moving information and the visiting information of the user U transmitted from the data collection device 20 (step S1). Then, the data aggregation device 10 associates the acquired moving information and the visiting information with each other for the same user U (step S2). At that time, the data aggregation device 10 associates the moving information and the visiting information of the same user U that are determined that the get-on position or the get-off position of the transportation means and the position of the shop D are almost the same positions that are positions corresponding to each other, and that the get-on time or the get-off time of the transportation means and the payment time at the shop D are almost the same time. In this way, the data aggregation device 10 associates the moving information with the visiting information that are information of the transportation means and the shop used by the same user at almost the same position at almost the same time.

Then, the data aggregation device 10 uses the moving information and the visiting information, associated with each other, to aggregate the paid amount of the user U for each transportation means. Then, the data aggregation device 10 calculates the amount to be returned to the service provider of the transportation means from the shop, by means of a predetermined calculation method such as multiplying the total paid amount for each transportation means by a predetermined rate (for example, 10% or 5%) (step S3).

As described above, according to the present embodiment, since the moving information and the visiting information of the user U are associated with each other, it is possible to recognize the information such as the transportation means and the shop used by the user U. By using such information, it is possible to perform various types of analysis on the relationship between the transportation means and the visited place. For example, it is possible to perform various types of analysis such as quantification of contribution to the paid amount such as points and mileage with respect to the transportation means and the like used by the user U, and quantification of contribution of the service provider of the transportation means with respect to the section, time, and the like in which the user used the transportation means and the like, in the paid amount by the user U. In addition, in the present embodiment, the amounts paid by the user U at the visited place such as a shop are aggregated for each transportation means, and a part thereof is calculated as an amount that should be returned to the service provider of the transportation means from the shop. As a result, according to the action of the user U in the area, that is, according to the paid amount at the visited place such as a shop for example, the service provider of the transportation means can gain more profit, which can further revitalize the area.

### <Modifications>

In the above description, the moving information and the visiting information of the user U are acquired by using the contactless IC card Uc held by the user U. However, the moving information and the visiting information of the user U may be acquired by another method. For example, as illustrated in FIG. 10, face authentication devices Ac, Ad, Bc, Cc, and Dc on which cameras are mounted are installed in the transportation means such as the train A, the bus B, and the taxi C and the visited place such as the shop D. It is assumed that the user U performs face authentication in advance and the feature amount extracted by the face authentication is associated with the identification information (ID) specifying the user U, and they are stored in the face authentication devices Ac, Ad, Bc, Cc, and Dc and a server device communicable with them. The face authentication devices Ac, Ad, Bc, Cc, and Dc perform face authentication on the user U who uses the transportation means and the visited place, and specify the identification information (ID) of the user U registered in advance. Then, the information acquisition devices Ac, Ad, Bc, Cc, and Dc installed in the transportation means and the visited place accumulate the moving information and the visiting information in association with the ID specified by the face authentication devices Ac, Ad, Bc, Cc, and Dc.

Further, as another example for acquiring the moving information and the visiting information of the user U, a mobile information processing terminal such as a smartphone Ut held by the user U may be used as illustrated in FIG. 11, instead of the above-described contactless IC card Uc. In that case, by using the contactless IC chip embedded in the smartphone Ut in the same manner as the contactless IC card Uc, the information acquisition devices Aa, Ab, Ba, Ca, and Da may store therein the moving information and the visiting information in association with the identification information of the user U. Alternatively, with use of an application incorporated in the smartphone Ut, it is also possible to accumulate the moving information and the visiting information in the smartphone Ut in association with the identification information of the user U through operation of the application by a person of the transportation means or the shop or by the user U, and transmit the information accumulated in the smartphone Ut to the information acquisition devices Aa, Ab, Ba, Ca, and Da and the data collection device 20.

### <Second Exemplary Embodiment>

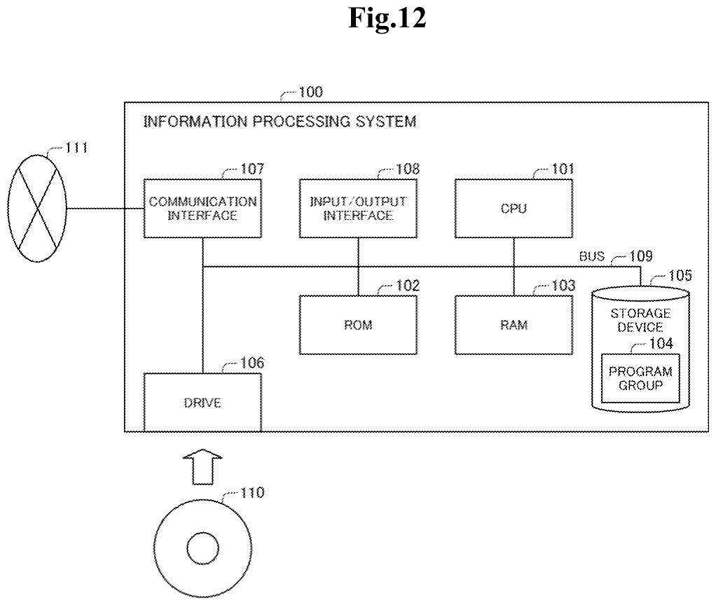

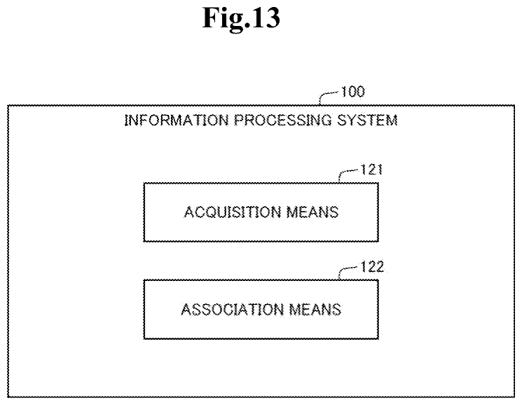

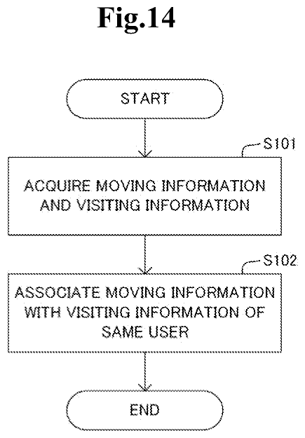

Next, a second exemplary embodiment of the present invention will be described with reference to FIGS. 12 to 14. FIGS. 12 and 13 are block diagrams illustrating the configuration of an information processing system according to the second exemplary embodiment, and FIG. 14 is a flowchart illustrating the operation of the information processing system. Note that the present embodiment shows the outlines of the configurations of the information processing system and the information processing method described in the above-described exemplary embodiment.

First, a hardware configuration of an information processing system 100 in the present embodiment will be described with reference to FIG. 12. The information processing system 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The information processing system 100 can construct, and can be equipped with, an acquisition means 121 and an association means 122 illustrated in FIG. 13, through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the acquisition means 121 and the association means 122 may be constructed by dedicated electronic circuits for implementing such means.

Note that FIG. 12 illustrates an example of a hardware configuration of an information processing device that is the information processing system 100. The hardware configuration of the information processing device is not limited to that described above. For example, the information processing device may be configured of part of the configuration described above, such as without the drive 106.

The information processing system 100 executes the information processing method illustrated in the flowchart of FIG. 14, by the functions of the acquisition means 121 and the association means 122 constructed by the program as described above.

As illustrated in FIG. 14, the information processing system 100 executes processing to
acquire moving information representing a use state of a transportation means by a user and visiting information representing a use state of a visited place by the user, in a predetermined area (step S101), and
store the moving information and the visiting information of the same user in association with each other (step S102).

With the configuration described above, since the moving information and the visiting information of the user are associated with each other, the present invention can easily recognize the transportation means used by the user and the visited place used by the user. As a result, it is possible to easily return a part of the amount paid at the visited place by the user to the transportation means used by the user. This enables the service provider of the transportation means to gain further profit, and to further revitalize the area.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), a flash ROM, and a RAM (Random Access Memory)). Note that the program may be supplied to a computer by being stored in a transitory computer-readable medium of any type. Examples of transitory computer-readable media include electric signals, optical signals, and electromagnetic waves. A transitory computer-readable medium can supply the program to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the acquisition means and the association means described above may be carried out by an information processing device provided and connected to any position on the network, that is, may be carried out by so-called cloud computing.

### <Supplementary Notes>

The whole or part of the exemplary embodiments disclosed above can be described as the following supplementary notes. Hereinafter, outlines of the configurations of an information processing method, an information processing system, and a program, according to the present invention, will be described. However, the present invention is not limited to the configurations described below.

(Supplementary Note 1)

An information processing method comprising:
acquiring moving information representing a use state of transportation means by a user and visiting information representing a use state of a visited place by the user, in a predetermined area; and
storing the moving information and the visiting information of a same user in association with each other.

### (Supplementary Note 2)

The information processing method according to supplementary note 1, further comprising:
acquiring the moving information including moving place information representing a use place of the transportation means by the user; and
storing the moving information and the visiting information in association with each other based on the moving place information included in the moving information.

### (Supplementary Note 3)

The information processing method according to supplementary note 2, further comprising
storing the moving information and the visiting information of the visited place located at a place corresponding to the moving place information included in the moving information, in association with each other.

### (Supplementary Note 4)

The information processing method according to supplementary note 3, further comprising:
acquiring the moving information including a get-on position or a get-off position of the transportation means by the user as the moving place information; and
storing the moving information and the visiting information of the visited place located at a place corresponding to the get-on position or the get-off position that is the moving place information included in the moving information, in association with each other.

### (Supplementary Note 5)

The image processing method according to any of supplementary notes 1 to 4, further comprising:
acquiring the moving information including moving time information representing a use time of the transportation means by the user, and acquiring the visiting information including visiting time information representing a use time of the visited place by the user; and
storing the moving information and the visiting information in association with each other based on the moving time information and the visiting time information.

### (Supplementary Note 6)

The information processing method according to supplementary note 5, further comprising
when the use time of the transportation means by the user that is the moving time information and the use time of the visited place by the user that is the visiting time information are within a predetermined time range, storing the moving information and the visiting information in association with each other.

### (Supplementary Note 7)

The image processing method according to any of supplementary notes 1 to 6, further comprising:
acquiring the visiting information including money amount information representing a paid amount at the visited place by the user; and
associating the moving information and the visiting information including the money amount information.

### (Supplementary Note 8)

The information processing method according to supplementary note 7, further comprising
based on the money amount information, calculating an amount to be returned to the transportation means corresponding to the moving information associated with the visiting information including the money amount information.

### (Supplementary Note 9)

An information processing system comprising:
an acquisition unit that acquires moving information representing a use state of transportation means by a user and visiting information representing a use state of a visited place by the user, in a predetermined area; and
an association unit that stores the moving information and the visiting information of a same user in association with each other.

### (Supplementary Note 10)

The information processing system according to supplementary note 9, wherein
the acquisition unit acquires the moving information including moving place information representing a use place of the transportation means by the user, and
the association unit stores the moving information and the visiting information in association with each other based on the moving place information included in the moving information.

### (Supplementary Note 11)

The information processing system according to supplementary note 10, wherein
the association unit stores the moving information and the visiting information of the visited place located at a place corresponding to the moving place information included in the moving information, in association with each other.

### (Supplementary Note 12)

The information processing system according to supplementary note 11, wherein
the acquisition unit acquires the moving information including a get-on position or a get-off position of the transportation means by the user as the moving place information, and
the association unit stores the moving information and the visiting information of the visited place located at a place corresponding to the get-on position or the get-off position that is the moving place information included in the moving information, in association with each other.

### (Supplementary Note 13)

The image processing system according to any of supplementary notes 9 to 12, wherein
the acquisition unit acquires the moving information including moving time information representing a use time of the transportation means by the user, and acquires the visiting information including visiting time information representing a use time of the visited place by the user, and
the association unit stores the moving information and the visiting information in association with each other based on the moving time information and the visiting time information.

### (Supplementary Note 14)

The information processing system according to supplementary note 13, wherein
when the use time of the transportation means by the user that is the moving time information and the use time of the visited place by the user that is the visiting time information are within a predetermined time range, the association unit stores the moving information and the visiting information in association with each other.

### (Supplementary Note 15)

The image processing system according to any of supplementary notes 9 to 14, wherein
the acquisition unit acquires the visiting information including money amount information representing a paid amount at the visited place by the user, and
the association unit associates the moving information and the visiting information including the money amount information.

### (Supplementary Note 16)

The information processing system according to supplementary note 15, further comprising
a calculation unit that, based on the money amount information, calculates an amount to be returned to the transportation means corresponding to the moving information associated with the visiting information including the money amount information.

### (Supplementary Note 17)

A computer-readable medium storing thereon a program for causing an information processing device to realize:
an acquisition unit that acquires moving information representing a use state of transportation means by a user and visiting information representing a use state of a visited place by the user, in a predetermined area; and
an association unit that stores the moving information and the visiting information of a same user in association with each other.

### (Supplementary Note 18)

The computer-readable medium storing thereon the program according to claim 17, wherein
the acquisition unit acquires the visiting information including money amount information representing a paid amount at the visited place by the user,
the association unit associates the moving information and the visiting information including the money amount information, and
the program further causes the information processing device to realize
a calculation unit that, based on the money amount information, calculates an amount to be returned to the transportation means corresponding to the moving information associated with the visiting information including the money amount information.

### REFERENCE SIGNS LIST

10 data aggregation device

11 acquisition unit

12 association unit

13 calculation unit

14 moving information storage unit

15 visiting information storage unit

16 association information storage unit

20 data collection device

A train

B bus

C taxi

D shop

U user

Uc contactless IC card

Ut smartphone

Aa, Ab, Ba, Ca, Da information acquisition device

Ac, Ad, Bc, Cc, Dc face authentication device

100 information processing system

101 CPU

102 ROM

103 RAM

104 program group

105 storage device

106 drive

107 communication interface

108 input/output interface

109 bus

110 storage medium

111 communication network

121 acquisition means

122 association means

What is claimed is:

1. An information processing method comprising:
acquiring moving information representing a use state of transportation means by a user and visiting information representing a use state of a visited place by the user, in a predetermined area; and
storing the moving information and the visiting information of a same user in association with each other.

2. The information processing method according to claim 1, further comprising:
acquiring the moving information including moving place information representing a use place of the transportation means by the user; and
storing the moving information and the visiting information in association with each other based on the moving place information included in the moving information.

3. The information processing method according to claim 2, further comprising storing the moving information and the visiting information of the visited place located at a place corresponding to the moving place information included in the moving information, in association with each other.

4. The information processing method according to claim 3, further comprising:
acquiring the moving information including a get-on position or a get-off position of the transportation means by the user as the moving place information; and
storing the moving information and the visiting information of the visited place located at a place corresponding to the get-on position or the get-off position that is the moving place information included in the moving information, in association with each other.

5. The image processing method according to claim 1, further comprising:
acquiring the moving information including moving time information representing a use time of the transportation means by the user, and acquiring the visiting information including visiting time information representing a use time of the visited place by the user; and
storing the moving information and the visiting information in association with each other based on the moving time information and the visiting time information.

6. The information processing method according to claim 5, further comprising when the use time of the transportation means by the user that is the moving time information and the use time of the visited place by the user that is the visiting time information are within a predetermined time range, storing the moving information and the visiting information in association with each other.

7. The image processing method according to claim 1, further comprising:
acquiring the visiting information including money amount information representing a paid amount at the visited place by the user; and
associating the moving information and the visiting information including the money amount information.

8. The information processing method according to claim 7, further comprising based on the money amount information, calculating an amount to be returned to the transportation means corresponding to the moving information associated with the visiting information including the money amount information.

9. An information processing system device comprising:
at least one memory configured to store instructions; and
at least one processor configured to execute instructions to:
acquire moving information representing a use state of transportation means by a user and visiting information representing a use state of a visited place by the user, in a predetermined area; and
store the moving information and the visiting information of a same user in association with each other.

10. The information processing device according to claim 9, wherein the at least one processor is configured to execute the instructions to:
acquire the moving information including moving place information representing a use place of the transportation means by the user, user; and
store the moving information and the visiting information in association with each other based on the moving place information included in the moving information.

11. The information processing device according to claim 10, wherein the at least one processor is configured to execute the instructions to
store the moving information and the visiting information of the visited place located at a place corresponding to the moving place information included in the moving information, in association with each other.

12. The information processing device according to claim 11, wherein the at least one processor is configured to execute the instructions to:
acquire the moving information including a get-on position or a get-off position of the transportation means by the user as the moving place information, information; and
store the moving information and the visiting information of the visited place located at a place corresponding to the get-on position or the get-off position that is the moving place information included in the moving information, in association with each other.

13. The image processing device according to claim 9, wherein the at least one processor is configured to execute the instructions to:
acquire the moving information including moving time information representing a use time of the transportation means by the user, and acquire the visiting information including visiting time information representing a use time of the visited place by the user, user; and
store the moving information and the visiting information in association with each other based on the moving time information and the visiting time information.

14. The information processing device according to claim 13, wherein the at least one processor is configured to execute the instructions to,
when the use time of the transportation means by the user that is the moving time information and the use time of the visited place by the user that is the visiting time information are within a predetermined time range, store the moving information and the visiting information in association with each other.

15. The image processing system device according to claim 9, wherein the at least one processor is configured to execute the instructions to:
acquire the visiting information including money amount information representing a paid amount at the visited place by the user, user; and
associate the moving information and the visiting information including the money amount information.

16. The information processing device according to claim 15, wherein the at least one processor is configured to execute the instructions to, based on the money amount information, calculate an amount to be returned to the transportation means corresponding to the moving information associated with the visiting information including the money amount information.

17. A non-transitory computer-readable medium storing thereon a program comprising instructions for causing an information processing device to execute processing to:
acquire moving information representing a use state of transportation means by a user and visiting information representing a use state of a visited place by the user, in a predetermined area; and
store the moving information and the visiting information of a same user in association with each other.

18. The non-transitory computer-readable medium storing thereon the program according to claim 17, the program causing the information processing device to execute the processing to:
acquire the visiting information including money amount information representing a paid amount at the visited place by the user, user;
associate the moving information and the visiting information including the money amount information, information; and
based on the money amount information, calculate an amount to be returned to the transportation means corresponding to the moving information associated with the visiting information including the money amount information.
